(19) United States
(12) Patent Application Publication
(10) Pub. No.: US 2007/0131467 A1
(43) Pub. Date: Jun. 14, 2007

(54) Bicycle Propulsion and Braking System and Method

(76) Inventor: Gerald Nicholas Pellegrini, Worcester, MA (US)

Correspondence Address: Gerald Nicholas Pellegrini, 37 Granby Rd., Worcester, MA, 01604, US

(21) Appl. No.: 11/306,017

(22) Filed: Dec. 14, 2005

(51) Int. Cl. B62M 23/02

(52) U.S. Cl. 180/205

(57) ABSTRACT

The present invention is a bicycle propulsion and braking system in which energy is stored as electrical energy and rotational kinetic energy. The rotational kinetic energy also serves as a means to provide gyroscopic stability of the bicycle. Energy transfer from the rotational kinetic energy to the bicycle provides acceleration of the bicycle. Energy transfer from the bicycle to the rotational kinetic energy provides braking of the bicycle. This energy transfer is accomplished through electromagnetic forces.

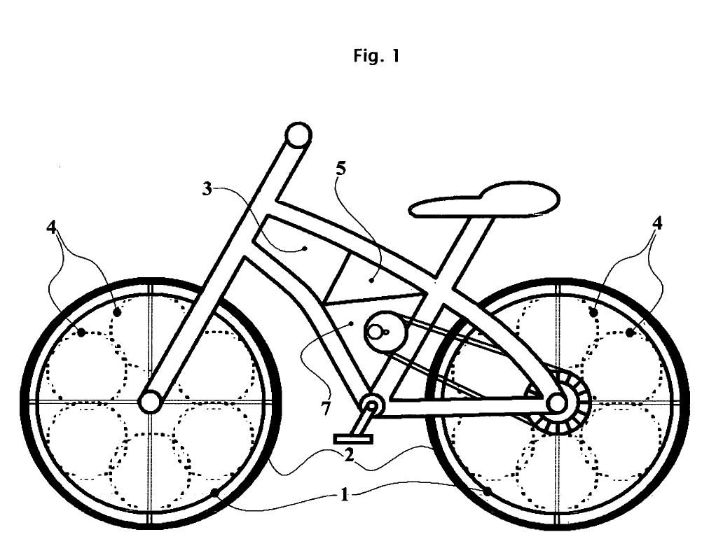

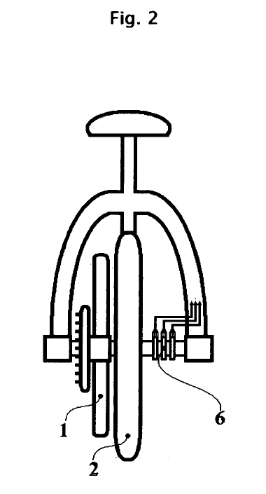

FIG. 1 is a side view of the invention illustrating references 1,2,3,4,5, and 7 described below. FIG. 2 is a rear view of the invention illustrating references 1,2, and 6 also described below.

A description of an embodiment of the invention is as follows:

In the invented bicycle propulsion and braking system energy is alternatively exchanged among rotating magnetic members (“gyros”) [1], independently rotating bicycle wheels that are coaxial with the gyros [2], and an electrical energy storage unit (“E.S.U.”) [3].

The bicycle wheels are electromagnetically coupled to the gyros through an electrical circuit comprising wheel coils [4] that are mechanically attached to the bicycle wheels such that EMFs are generated in the wheel coils when there is relative motion between the gyros and the bicycle wheels. The wheel coils are wound as 3-phase windings, by which the relative speed, in both magnitude and direction, between the gyros and bicycle wheels may be determined from knowledge of the generated 3-phase EMFs. A reference speed is defined as the bicycle wheel speed at which zero EMF is generated. The E.S.U., consisting of capacitors or batteries, or a combination of the two is used to store electrical energy. An electric current control circuit (“E.C.C.”) [5] is used to control electric current flow between the wheel coils and the E.S.U. such that torques are produced between the gyros and the bicycle wheels. The E.C.C. is electrically connected to the rotating wheel coils through brushes and slip rings [6] mounted on the wheel axles. The drawings only show the brushes and slip rings on the back bicycle wheel axle, but similar brushes and slip rings are also mounted on the front bicycle wheel axle. It may be desirable to have a primary power source that provides mechanical power to at least one bicycle wheel or to the gyros such that the gyros are always rotating in the positive direction (i.e., direction of rotation of bicycle wheels corresponding to forward movement of bicycle). This primary source can be human power, or an auxiliary gasoline or similar engine [7]. The E.C.C. may provide separate current control to the front and back wheel coils such that the front and back gyros rotate at the same speed.

Since the gyros are mounted coaxially with the bicycle wheels, the gyros provide for gyroscopic stability of the bicycle. Also, since the gyros rotate independently from the bicycle wheels, kinetic energy may be stored in the gyros independently of the bicycle's motion.

Acceleration, or propulsion, of the bicycle is accomplished by imparting positive torque (i.e., torque tending to propel the bicycle) to the bicycle wheels as follows:

When the speed of the bicycle wheels is below the reference speed the E.C.C. controls the current from the wheel coils such that the wheel coils and gyros act as an electrical generator producing torques on the gyros and bicycle wheels that decrease the relative speed between the gyros and bicycle wheels. This action provides for a positive (propulsion) torque on the bicycle wheels, and a corresponding negative (braking) torque on the gyros. In this process kinetic energy from the gyros is converted into electrical energy for storage in the E.S.U. and kinetic energy of the bicycle.

When the speed of the bicycle wheels is above the reference speed the E.C.C. controls the current to the wheel coils such that the wheel coils and gyros act as an electrical motor producing torques on the gyros and bicycle wheels that increase the relative speed between the gyros and bicycle wheels. This action again provides for a positive (propulsion) torque on the bicycle wheels, and a corresponding negative (braking) torque on the gyros. In this process kinetic energy from the gyros and electrical energy from the E.S.U. is converted into kinetic energy of the bicycle.

Deceleration, or braking, of the bicycle is accomplished by imparting negative torque (i.e., torque tending to brake the bicycle) to the bicycle wheels as follows:

When the speed of the bicycle wheels is above the reference speed the E.C.C. controls the current from the wheel coils such that the wheel coils and gyros act as an electrical generator producing torques on the gyros and bicycle wheels that decrease the relative speed between the gyros and bicycle wheels. This action provides for a negative (braking) torque on the bicycle wheels, and a corresponding positive (propulsion) torque on the gyros. In this process kinetic energy from the bicycle is converted into kinetic energy of the gyros and electrical energy for storage in the E.S.U.

When the speed of the bicycle wheels is below the reference speed the E.C.C. controls the current to the wheel coils such that the wheel coils and gyros act as an electrical motor producing torques on the gyros and bicycle wheels that increase the relative speed between the gyros and bicycle wheels. This action again provides for a negative (braking) torque on the bicycle wheels, and a corresponding positive (propulsion) torque on the gyros. In this process kinetic energy of the bicycle and electrical energy from the E.S.U. is converted into kinetic energy of the gyros.

The described electromechanical system provides for the propulsion and regenerative braking of the bicycle, and the storage of energy in both kinetic and electrical forms. This system has the advantage of recapturing the bicycle's kinetic energy in the braking process thereby conserving the overall energy consumption of the primary source, and at the same time also providing for gyroscopic stability for the bicycle over a wide range of bicycle speeds including zero bicycle speed.

What is claimed is:

1. A bicycle comprising:
first means for providing electrical energy storage;
an electric current control circuit; and
a rotating member;
wherein mechanical energy storage and gyroscopic stability for said bicycle are provided for by the rotational speed of said member, said member being magnetically coupled to one or more wheels of said bicycle such that an EMF is generated in an electrical circuit when there is relative speed between said member and said wheels, said control circuit providing electrical energy to said circuit from said first means thereby creating first mechanical forces between said member and said wheels, said first forces tending to increase the relative speed between said member and said wheels, said control circuit also providing electrical energy to said first means from said circuit thereby creating second mechanical forces between said member and said wheels, said second forces tending to decrease the relative speed between said member and said wheels, said first forces being used to brake said bicycle when the speed of said wheels is below a reference speed and being used to propel said bicycle when the speed of said wheels is above said reference speed, said second forces being used to propel said vehicle when the speed of said wheels is below said reference speed and being used to brake said vehicle when the speed of said wheels is above said reference speed.

2. A method for propelling and braking a bicycle comprising:
a first step of storing electrical energy;
a second step of utilizing electrical energy;
a third step of storing rotational kinetic energy, said rotational kinetic energy having associated with it a rotating member;
a fourth step of utilizing said rotational kinetic energy;
said third step also providing for gyroscopic stability of said bicycle;
electromagnetically coupling one or more wheels of said bicycle to said member;
whereby said first and fourth steps propel said bicycle through said coupling when the speed of said wheels is below a reference speed, and whereby said second and fourth steps propel said bicycle through said coupling when the speed of said wheels is above said reference speed, and whereby said second and third steps brake said bicycle through said coupling when the speed of said wheels is below said reference speed, and whereby said first and third steps brake said bicycle through said coupling when the speed of said wheels is above said reference speed.
